(19) United States
(12) Patent Application Publication
(10) Pub. No.: US 2021/0171762 A1
(43) Pub. Date: Jun. 10, 2021

(54) PLASTIC PREFORM AND CONTAINER INCLUDING AN ADDITIVE

(71) Applicant: Plastipak Packaging, Inc., Plymouth, MI (US)

(72) Inventors: Marco Paschino, Verbania (IT); Miguel Vieira, Vilvoorde (BE)

(21) Appl. No.: 15/734,397

(22) PCT Filed: Jun. 7, 2019
(86) PCT No.: PCT/US2019/036020

§ 371 Date: Dec. 2, 2020

Related U.S. Application Data
(60) Provisional application No. 62/681,854, filed on Jun. 7, 2018.

(51) Int. Cl. C08L 67/02; C08L 33/10; C08K 3/013; C08K 3/22

(52) U.S. Cl. CPC C08L 67/02; C08L 33/10; C08K 2003/2237; C08K 3/22; C08K 3/013

(57) ABSTRACT

A plastic preform including polyethylene terephthalate (PET) and an EMA additive is disclosed. With embodiments the preform may include a second additive, which may comprise a colorant. Embodiments of plastic containers comprising PET and an EMA additive are also disclosed.

### CROSS-REFERENCE TO RELATED APPLICATION

This application is a National Stage Patent Application of International Patent Application PCT/US2019/036020, filed Jun. 7, 2019, which claims the benefit of priority to U.S. Provisional Application Ser. No. 62/681,854, filed Jun. 7, 2018, which is fully incorporated herein by reference

### TECHNICAL FIELD

The present invention relates to plastic containers and preforms, including plastic containers and preforms that include an additive to improve chemical characteristics of polyethylene terephthalate (PET).

### BACKGROUND

Plastic preforms and containers, including those associated with injection molding processes, are known in the art. Manufacturers of plastic containers commonly desire to provide containers with certain characteristics, including performance and chemical-resistance characteristics. For some applications, such as for a barrier, manufacturers have employed barrier materials, such as Nylon-MXD6, as the molding specifications for Nylon-MXD6 can match well with other plastic materials (including polyethylene terephthalate (PET), polypropylene (PP), or polyethylene (PE)) with co-injection and co-extrusion.

However, Nylon-MXD may not be easily sourced or ideal for all plastic container applications, including those involving PET preforms and containers.

Consequently, for certain applications, including those involving PET preforms and containers, other configurations—including those involving additives—may be desirable. Among other things, it can be desirable to provide plastic containers and preforms with an additive to improve characteristics, including chemical characteristics. It may be particularly desirable to provide PET plastic preforms and containers with increased chemical resistance, such as for example, in connection with high PH or corrosive product contents.

### SUMMARY

A plastic preform including polyethylene terephthalate (PET) and an EMA additive is disclosed. With embodiments, the preform may include a second additive, which may include a colorant. Embodiments of plastic containers comprising PET and an EMA additive are also disclosed.

### BRIEF DESCRIPTION OF THE DRAWINGS

Embodiments of the disclosure will now be described, by way of example, with reference to the accompanying drawings, wherein:

FIG. 1 is a perspective view of an embodiment of a plastic container according to aspects or teachings of the present disclosure;

FIG. 2 is front elevational view of the plastic container illustrated in FIG. 1;

FIG. 3 is a bottom plan view of the plastic container illustrated in FIG. 1;

FIG. 4 is a section view along lines B-B of a portion of the plastic container illustrated in FIG. 3;

FIG. 5 is a front elevation view of a portion (neck) of the plastic container illustrated in FIG. 2;

FIG. 6 is a perspective illustration of a preform including an EMA additive; and

FIG. 7 is a perspective illustration of a preform including an EMA additive and a colorant.

### DETAILED DESCRIPTION

Reference will now be made in detail to embodiments of the present disclosure, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined herein and by appended claims.

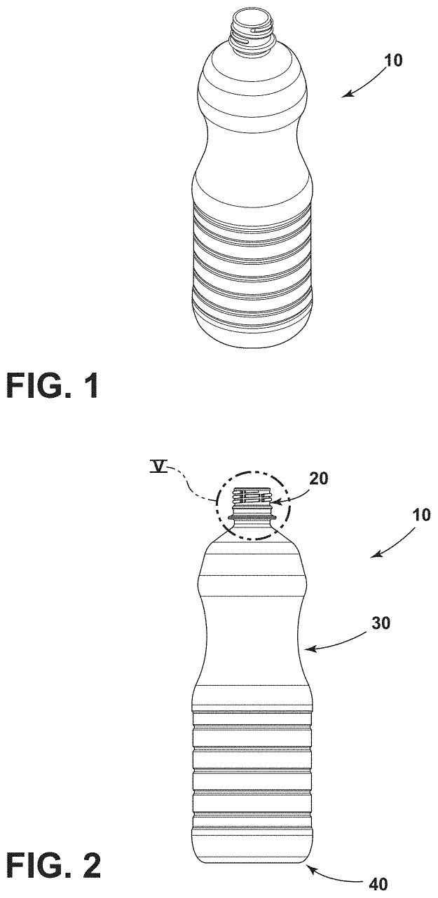

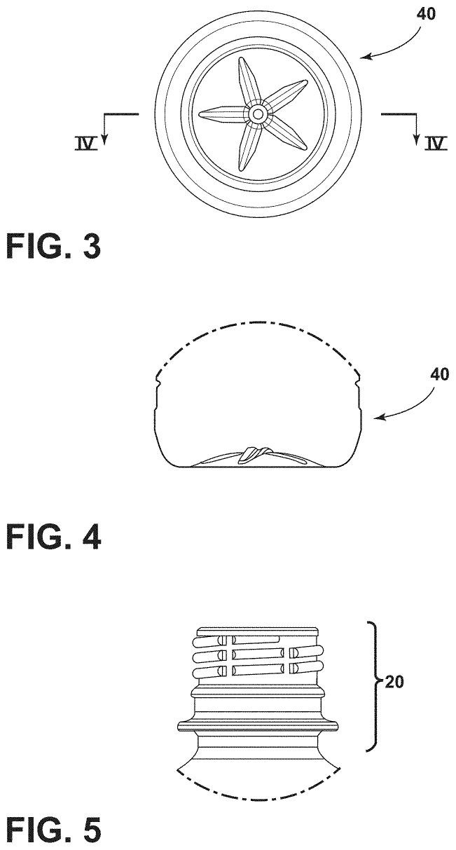

With reference to FIGS. 1-5, and without limitation, an embodiment of a plastic container 10 in accordance with aspects and teachings of the present disclosure is generally illustrated. The container includes a neck 20, a sidewall 30, and a base 40. The plastic container may be blow molded from a plastic preform in various manners as are known in the field. The illustrated plastic container may be comprised of PET. For example, and without limitation, such a plastic container may have a neck with a PCO-28 finish, a weight of 28.0±0.5 grams, and a content capacity of 1000±5.0 ml.

With embodiments, the plastic container may be comprised of PET and may further include one or more additives—which may comprise or include an ethyl methyl acrylate (EMA) copolymer. An example of an additive that may be used in connection with the present disclosure is EMAC SP2404 (EMAC), which is an 18.5% EMA copolymer that is commercially available from Westlake Polymers.

With embodiments of the present disclosure, plastic preforms may be provided that include PET and an EMA additive. Such plastic preforms may be formed into containers using various means known in the field. The EMA additive (such as EMAC) may be used during the injection process and may, among other things, improve the chemical characteristics associated with the PET. For example, the inclusion of the EMA additive may increase the resistance of the PET material with respect to high PH products (e.g., up to 10) and/or corrosive products. Various embodiments of the PET bottles (with an EMA additive) may, for example and without limitation, be suitable for use in connection with acetone, sodium hypochlorite, ammonia, petrol, and/or benzene. As such, plastic containers employing the present teachings may have use in various challenging market segments, including, market segments involving industrial products and/or chemical products (such as detergents). It has been found that, for a number of applications, the inclusion of an EMA additive with PET can be a suitable replacement for barrier materials, such as Nylon-MXD6.

The inclusion of an EMA additive (e.g., EMAC) with a PET container has been found to, among other things, impart improved flexibility and strength. The inclusion of such an EMA additive can impart superior elasticity and low temperature performance, and, in many applications with PET, can improve stress cracking resistance. Moreover, embodiments of PET articles produced with such an EMA additive may exhibit very high coefficient of friction (COF) without the addition of slip or anti-blocking agents.

The disclosure includes and contemplates PET preforms and containers that include a range of EMA additive (e.g., EMAC). The amount of EMA additive for some embodiments may be about 0.5% to about 20% (by weight). Without limitation, for some specific plastic preform and container embodiments, the amount of EMA additive included may be about 1%, about 2%, about 4%, about 5%, about 10%, or about 20%. For a number of embodiments, the amount of EMA additive will range from about 2% to about 6%, with other embodiments, the amount of EMA additive may range from about 2% to about 4%. Embodiments of plastic preforms or containers may further include one or more further additives, such as one or more colorants, that can, among other things, provide a measure of sunlight or ultraviolet (UV) ray protection. A colorant may comprise colored pigment, such as for example and without limitation, white, yellow, or green pigments.

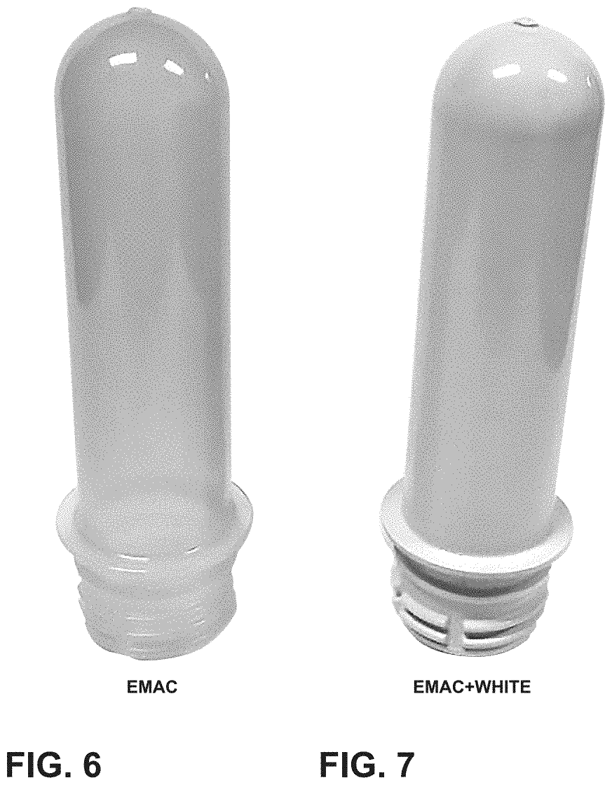

FIGS. 6 and 7 generally illustrate preforms in accordance with aspects and teachings of the present disclosure. An embodiment of a preform that includes an EMA additive—in this instance, EMAC—is generally illustrated in FIG. 6. FIG. 7 generally illustrates an embodiment of a preform that includes an EMA additive (i.e., EMAC) and a colorant (e.g., a white colorant). Preforms may include various features known in the field, including, without limitation threads and a support formation, such as a support flange. Moreover, preforms contemplated by the present disclosure are not limited to the types, sizes, dimensions, and/or configurations shown.

Additionally, for some embodiments, titanium oxide (TiO2) may be included as an additional additive (in addition to, in combination with, an EMA additive), and may provide a notable or surprising effect. Among other things, TiO2 may serve as a white pigment (with opacity) that can be a good photocatalyst or semi-conductor, and which can absorb portions of visible light. For some applications, TiO2 can help absorb UV light energy, which can protect the polymer from UV degradation. For example and without limitation, with some embodiments, PET containers and preforms may include about 2% to about 6% EMAC (as an EMA additive), along with a further additive for opacity that ranges from about 4% to about 10%.

By way of example and without limitation, in an embodiment, a plastic container may be formed from a PET preform (e.g., a 28 g. preform) comprising approximately 92% PET, 2% EMA additive (e.g., EMAC), and 6% colorant. In another embodiment, a plastic container may be formed from a PET preform (e.g., a 28 g preform) comprising approximately 91.5% PET, 4% EMA additive (e.g., EMAC), and 4.5% colorant. As the term is used herein, the references to percentages (including percentage references with respect to total composition) are typically with reference to weight.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims and their equivalents.

What is claimed:

1. A plastic preform, the preform comprising:
polyethylene terephthalate (PET); and
an ethyl methyl acrylate (EMA) additive.

2. The preform of claim 1, wherein the EMA additive comprises an ethyl methyl acrylate (EMA) copolymer.

3. The preform of claim 1, wherein the EMA additive comprises from about 0.5% to about 20% of a total composition of the preform.

4. The preform of claim 1, wherein the EMA additive comprises about 0.5% of a total composition of the preform.

5. The preform of claim 1, wherein the EMA additive comprises about 1.0% of a total composition of the preform.

6. The preform of claim 1, wherein the EMA additive comprises about 2.0% of a total composition of the preform.

7. The preform of claim 1, wherein the EMA additive comprises about 4.0% of a total composition of the preform.

8. The preform of claim 1, wherein the EMA additive comprises about 5.0% of a total composition of the preform.

9. The preform of claim 1, wherein the EMA additive comprises about 10.0% of a total composition of the preform.

10. The preform of claim 1, wherein the EMA additive comprises about 20.0% of a total composition of the preform.

11. The preform of claim 1, wherein the EMA additive comprises an 18.5% EMA copolymer.

12. The preform of claim 1, wherein the EMA additive ranges from about 2.0% to about 6.0% of a total composition of the preform.

13. The preform of claim 1, wherein the EMA additive ranges from about 2.0% to about 4.0% of a total composition of the preform.

14. The preform of claim 1, including a second additive.

15. The preform of claim 14, wherein the second additive includes a colorant.

16. The preform of claim 14, wherein the second additive comprises one or more colored pigments.

17. The preform of claim 14, wherein the second additive comprises titanium oxide (TiO2).

18. A plastic container formed from a plastic preform comprising polyethylene terephthalate (PET) and an ethyl methyl acrylate (EMA) additive.

19. The plastic container of claim 18, including a second additive.

20. The plastic container of claim 19, wherein the second additive comprises a colorant.

21. The plastic container of claim 19, wherein the second additive comprises titanium oxide (TiO2).

22. The plastic container of claim 18, wherein the plastic container comprises about 92% PET, 2% EMA additive, and about 6% of a colorant or titanium oxide (TiO2).

23. The plastic container of claim 18, wherein the plastic container comprises about 91.5% PET, 4% EMA additive, and about 4.5% of a colorant or titanium oxide (TiO2).
